(19) United States
(12) Patent Application Publication
(10) Pub. No.: US 2005/0127089 A1
(43) Pub. Date: Jun. 16, 2005

(54) Method and apparatus for reducing operating and maintenance costs and emissions in a chemical and/or fluid injection system

(76) Inventors: Galen B. Schacher, Bawlf (CA); Robert E. Lee, Camrose (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/737,176

(22) Filed: Dec. 16, 2003

(51) Int. Cl. G01F 11/00

(52) U.S. Cl. 222/1

(57) ABSTRACT

An apparatus for reducing operating costs, maintenance costs and emissions in a fluid injection system, which includes a valve assembly adapted to be connected to a fluid injection point located on a well. The valve assembly has an electronic controller, a flow passage, a plurality of solenoid valves positioned in the flow passage, and a metering chamber positioned in the flow passage that is adapted to receive and discharge fluid flowing through the flow passage into the injection point. The electronic controller supplies signals to selectively open and close each of the plurality of solenoid valves to control the flow of the fluid along the flow passage into the metering chamber and to control the discharge of the fluid from the metering chamber along the flow passage into the injection point.

### FIELD OF THE INVENTION

The present invention relates to a method and an apparatus for reducing operations and maintenance costs and emissions in a chemical and/or fluid injection system.

### BACKGROUND OF THE INVENTION

There are numerous pumping installations in which pumps are used to convey liquids. An example of such an installation is a methanol injection pumping installation associated with natural gas production facilities.

As natural gas flows through piping, water vapour in the natural gas tends to condense and freeze, forming ice plugs in the piping. In order to prevent these ice plugs from forming, methanol is injected into areas of the piping that have been identified as being prone to the development of ice plugs. Each methanol injection installation uses a pump.

A factor in the economic viability of these pumping installations is rising operating costs relating to the operation and maintenance of the pumps. A further factor is the cost of complying with environmental standards relating to emissions from the pumps, as stricter environmental regulations are introduced.

### SUMMARY OF THE INVENTION

What is required is a method and an apparatus for reducing operating and maintenance costs and emissions in a pumping and/or injection system. According to one aspect of the present invention there is provided a method for reducing operating and maintenance costs and emissions in a pumping and/or injection system.

A first step involves providing an electronic controller consisting of an electronic monitoring and control system and a power supply making up the control box. A metering chamber and four solenoid activated valves make up the valve assembly. The invention sends a series of pulses from the control box via the electrical cable. The signals cause the solenoid valves to open and close, first filling the metering chamber with fluid and then discharging the fluid into the desired injection points, constituting one cycle. The number of cycles needed per day would be determined by the size of the metering chamber and the volume of fluid required to be discharged into the desired injection points. The fluid for the system would be supplied to the valve assembly by a tank or vessel mounted on a stand located at a higher elevation than the injection point, thus providing a gravity feed effect to the valve assembly.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a diagrammatic sketch illustrating the component parts of the electronic flow controller system for the reduction of operating costs, maintenance costs and emissions;

FIG. 2 is a diagrammatic sketch showing typical locations for installation of the electronic flow controller;

FIG. 3 is schematic illustrates partly in block diagram, the interconnection of the valves and metering chamber of the valve assembly; and

FIG. 4 is schematically illustrates, party in block diagram, the electrical circuitry used in the initial embodiment of the of the controller panel of FIG. 1.

### DETAILED DESCRIPTION OF THE PREFERRED EMBODIMENT

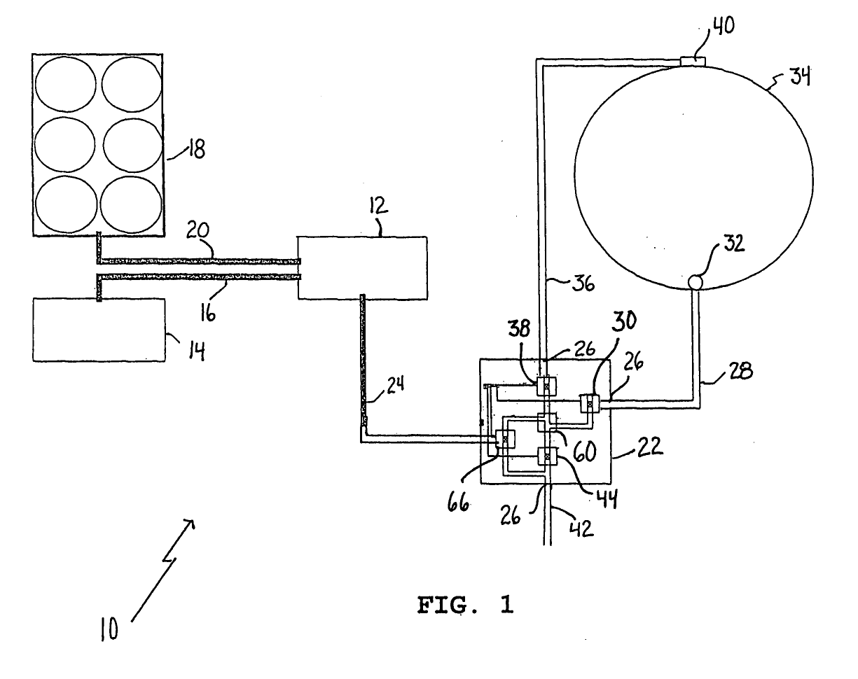

The preferred embodiment, an electronic flow controller system generally identified by reference numeral 10, will now be described with reference to FIGS. 1 through 4.

Structure and Relationship of Parts:

Referring to FIG. 1, there is illustrated an electronic flow controller system 10 which includes a panel 12 which is connected to a battery box 14 by an electrical cable 16, and also connected to photo voltaic array 18 by an electronic cable 20. Electronic flow controller panel 12 is also connected to a valve assembly 22 by an electrical cable 24. Threaded outlet parts 26 are provided on valve assembly 22. Each of the threaded outlet parts 26 permit a connective passage to be coupled to valve assembly 22. A first connective passage 28 connects a fill valve 30 of valve assembly 22 to a suction point 32 of chemical tank 34. A second connective passage 36 connects a vent valve 38 of valve assembly 22 to a vent/fill port 40 of chemical tank 34. A third connective passage 42 connects a dump valve 44 of valve assembly 22 to the desired injection point.

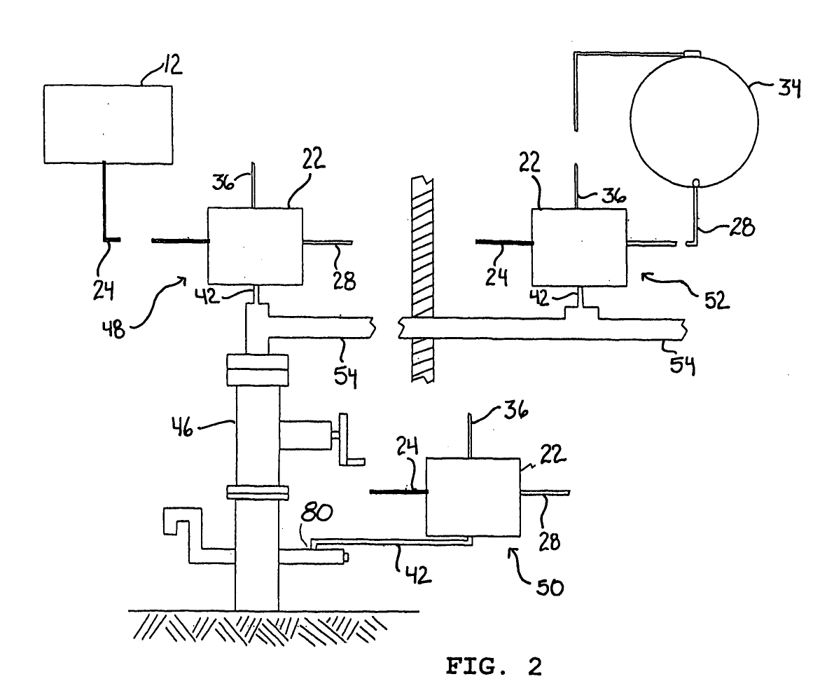

Referring to FIG. 2, three different typical injection points on a gas well location are illustrated. A first injection point includes valve assembly 22 associated with a flow “T”, generally referenced by number 48. Valve assembly 22 is connected to wellhead 46 by third connective passage 42. First connective passage 28 extends from valve assembly 22 to connect to suction port 32 of chemical tank 34. Second connective passage 36 connects valve assembly 22 to vent/fill port 40 of chemical tank 34. Electrical cable 24 connects valve assembly 22 to controller panel 12.

A second injection point is valve assembly 22 associated with a casing, generally referenced by numeral 50. Valve assembly 22 is connected to wellhead 46 by third connective passage 42. First connective passage 28 from valve assembly 22 connects to suction port 32 of chemical tank 34. Second connective passage 36 connects valve assembly 22 to vent/fill port 40 of chemical tank 34. Electrical cable 24 connects valve assembly 22 to controller panel 12.

A third injection point is valve assembly 22 associated with a flow line generally referenced by numeral 52. Valve assembly 22 connects to flow line 54 by third connective passage 42. First connective passage 28 extends from valve assembly 22 to connect to suction port 32 of chemical tank 34. Second connective passage 36 connects valve assembly to vent/fill port 40 of chemical tank 34. Electrical cable 24 connects valve assembly 22 to controller panel 12.

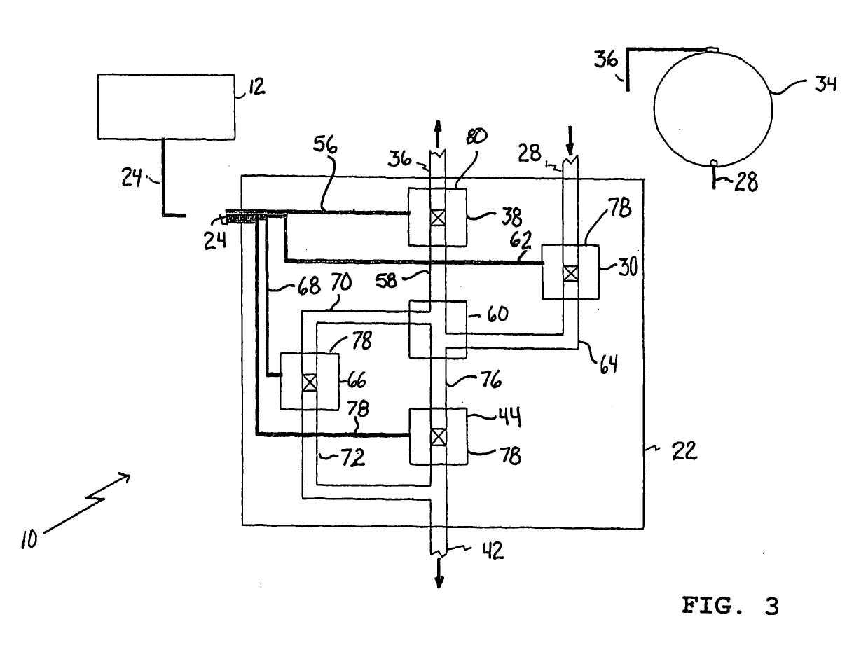

Referring to FIG. 3, vent valve 38 is connected to controller panel 12 by means of electrical cable 56 via electrical cable 24. Second connective passage 36 connects vent valve 38 to vent/fill port 40 of chemical tank 34. A forth connective passage 58 connects vent valve 38 to metering chamber 60 adapted to received and discharge a fluid such as a chemical.

Fill valve 30 of valve assembly 22 is connected to controller panel 12 by means of electrical cable 62 via electrical cable 24. First connective passage 28 connects fill valve 30 to suction port 32 of chemical tank 34. A fifth connective passage 64 connects fill valve 30 to metering chamber 60.

Valve assembly's 22 equalization valve 66 is connected to controller panel 12 by means of electrical cable 68 via electrical cable 24. A sixth connective passage 70 connects equalization valve 66 to metering chamber 60. A seventh connective passage 72 connects equalization valve 66 to discharge passage 42. An eighth connective passage 74 connects discharge valve 44 to metering chamber 60. Third connective passage 42 connects discharge valve 44 to desired injection point. Discharge valve 44 is connected to controller panel 12 by means of electrical cable 30 via electrical cable 24.

Operation:

The use and operation of electronic flow controller will now be described with reference to FIGS. 1 through 4.

FIG. 3 illustrates valve assembly 22, in which controller panel 12 sends electrical pulses to solenoid valves 78 via electrical cable 76. Solenoid valves 78 include fill valve 30, vent valve 38, dump valve 44 and equalization valve 66. Controller panel 12 sends a series of pulses to valves 78 of valve assembly 22 to fill and discharge fluid from chemical tank 34 via gravity into typical discharge points such as well head 46, flowline 54, or flow line 80 as illustrated in FIG. 2.

Valves 78 in FIG. 3 start their sequencing cycle with vent valve 38 opening by means of a pulse delivered by electrical cable 56. The opening of vent valve 38 connects metering chamber 60 to vent/fill port 40 of chemical tank 34 through second connective passage 36 and forth connective passage 58. This vents or relieves any pressure which may be present in metering chamber 60 to ambient. Vent valve 38 remains open.

The control panel 12 sends a pulse through electrical cable 62 to open fill valve 30, connecting metering chamber 60 to suction port 32 of chemical tank 34 via first connective passages 28 and fifth connective passage 64. Now metering chamber 60 fills with chemical which further displaces any gaseous vapor present in metering chamber 60, through second connective passage 36 and forth connective passage 58 and vent valve 38.

Control panel 12 now sends a pulse through electrical cable 56 to close vent valve 38 and follows this with a pulse through electrical cable 62 to close fill valve 30. Valves 80 are now in normally closed position. Control panel 12 sends a pulse to open equalization valve 66 through electrical cable 68.

This applies the pressure present in third connective passage 42 to metering chamber 60 via sixth connective passage 70 and seventh connective passage 72. Equalization valve 66 now remains open and maintains metering chamber 60 at the same pressure as third connective passage 42.

Control panel 12 sends a pulse through electrical cable 76 to open valve 80. Gravity causes the fluid in metering chamber 60 to flow through eighth connective passage 74 and dump valve 44 into third connective passage 42. The fluid flows from third connective passage 42 into the desired injection point. Control panel 12 now sends a pulse through electrical cable 68 to close valve 78, followed by a pulse through electrical cable 76 to close dump valve 44. Now metering chamber 60 is void of fluid, but is at the same pressure as injection point. This would then complete one full cycle.

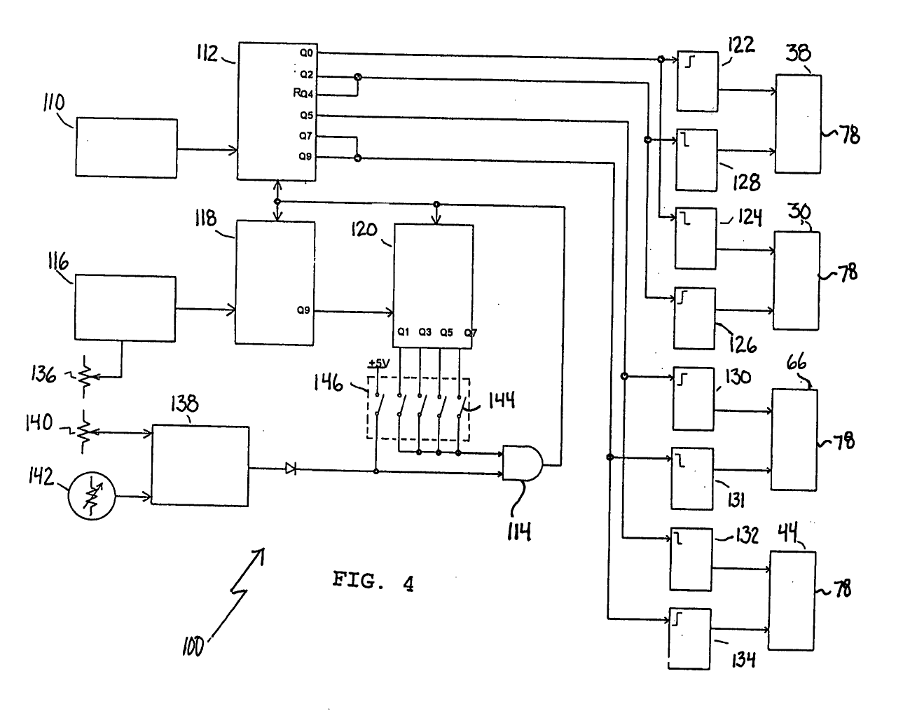

When the cycle starts again by a pulse from control panel 12 through electrical cable 56 to open vent valve 38, any pressure in metering chamber 60 will vent to chemical tank 34 through second connective passage 36 and forth connective passage 58 starting a new cycle. The amount of chemical required on a daily basis will determine the number of cycles required per day. This can be calculated based on the volume of metering chamber 60. Referring now to FIG. 4, controller panel will be illustrated in greater detail. Controller 12 consists of a charging circuit for a battery located in battery box 14 and a power supply in addition to the functional blocks indicated FIG. 4. The charging circuit is an embodiment of one of the popular three-terminal adjustable regulators configured as a constant voltage charger, while the power supply is a common embodiment of one of the popular three-terminal fixed voltage five volt regulators, both familiar to one skilled in the trade.

### Alternative Embodiments

Referring to FIG. 4, there is illustrated an alternative embodiment of the electronic flow controller, generally referenced by numeral 100. Electronic flow controller 100 illustrated in FIG. 4 illustrates a very simple embodiment of the circuit utilizing oscillators 110, a first counter logic counter/dividers 112, a second counter logic counter/divider 118, a third counter logic/devider 120 and associated driving electronics, to control the sequence of solenoid valves 78 with minimal external inputs other than the ability to activate or deactivate the circuit based on a temperature measurement. Alternate embodiment 100 utilizes one of the single integrated circuit micro-controllers such as those manufactured by Microchip Technology Inc., 2355 West Chandler Blvd., Chandler, Ariz., with suitable driving electronics to operate solenoid valves 78. This embodiment 100 allows additional external input and control of the device. Yet another embodiment of controller can utilize one of the smaller PLCs (Programmable Logic Controllers) available in the industrial marketplace.

Alternative embodiment 100 illustrated in FIG. 4 was designed to operate with solenoid valves 78 of the latching type, that is, a valve of the type which only requires a short duration electrical pulse to cycle it open and similarly a short duration electrical pulse to cycle it closed. Valves 78 have the capability to remain in either the open or closed position without the presence of continuous electrical energy. This is an advantage in remote locations where the system must operate from solar power as it reduces the size of solar panel and the battery required and the accompanying cost for the same. In applications where electrical energy requirements may not be a concern, such as locations served by utility power, an alternate embodiment of the circuit can use normally powered solenoid valves 78, that is, solenoid valves 78 which require continuous electrical power to maintain them in the open position, and which close when power is removed.

The sequencing of a complete cycle of the four solenoid valves 78 of valve assembly 22, is controlled by oscillator 110 and first counter/divider integrated circuit 112. Oscillator 110 has a period of oscillation of approximately 1 second. The period of this oscillation can be altered by component changes to the electronic circuit to increase or decrease the step time to account for the viscosity of different fluids which may be flowing through the valve assembly 22. The output of oscillator 110 causes each of the ten outputs of the decade counter/divider 112 to produce a square wave logic output pulse in sequence, starting with QO and continuing through Q9. When the Q9 output delivers its pulse, this signal inhibits first decade counter/divider 112 from continuing to count until a reset pulse is received from an AND gate 114. The variable frequency oscillator 116, with its associated counter/dividers 118 and 120 determine the time delay between the complete cycles controlled by oscillator 110 and counter/divider 112.

Referring to FIG. 4, a more detailed description of one complete cycle is as follows:

As QO delivers the rising edge of its logic output waveform, one-shot 122 is triggered, delivering an electrical pulse to the solenoid coil of vent valve 15, causing it to latch open. On the falling edge of the waveform. from QO, one-shot 124 is triggered, delivering a pulse to fill valve 16, causing it to latch open. Q1 and Q2 waveforms extend the time period that valves 15 and 16 are open. This condition now allows fluid to flow into chamber 19 of FIG. 3. As Q3 delivers the rising edge of its logic output waveform, one-shot 126 delivers a pulse to latch the fill valve 16 closed. On the falling edge of the waveform from Q3, one-shot 128 delivers a pulse to vent valve 15 to latch it closed. The flow of fluid into chamber 19 now ceases. The output waveform from Q4 is not used. As Q5 delivers the rising edge of its logic output waveform, one-shot 130 is triggered, delivering an electrical pulse to the solenoid coil of equalize valve 66, causing it to latch open. On the falling edge of the waveform from Q5, one-shot 132 is triggered, delivering an electrical pulse to the solenoid coil of dump valve 44, thus latching it open and allowing chamber 60 to empty. The output from Q6 and Q7 are used to extend the time to allow the chamber 60 to empty. As Q8 delivers the rising edge of its logic output waveform, one-shot 134 is triggered, delivering an electrical pulse to the solenoid coil of the dump valve 44, latching it closed. The falling edge of the Q8 waveform triggers one shot 131, delivering an electrical pulse to the solenoid coil of equalizer valve 66, causing it to latch closed. The logic output waveform of Q9 is coupled to the clock enable of first counter/divider 112 inhibiting further operation of the circuit until a reset is provided by an output waveform from gate 114. This completes one cycle.

The frequency with which the above described cycle occurs is determined by the variable frequency oscillator 116 and the second counter/dividers 118 and third counter/divider 120. First potentiometer 136 varies the frequency of the variable frequency oscillator 116. The output of the oscillator 116 is coupled to second counter divider 118, which is configured to divide the frequency by 10. The output of second counter/divider 118 is coupled to third counter/divider 120 to further divide the frequency. Outputs Q1, Q3, Q5, Q7 of third counter/divider 120, selected by the appropriate switches 142, further divide the frequency by 2, 4, 6, and 8. Thus the original frequency of second counter divider 118 is divided by factors of 20, 40, 60 and 80, providing an effective period of oscillation of up to several minutes. The selected output of third counter divider 120 is applied to the input of gate 114. If the second input of gate 114 is at a HIGH logic level at same the time the selected output waveform of third counter/divider 120 goes to a HIGH level, the output of gate 114 delivers a reset pulse to first counter divider/112, second counter/dividers 118, and third counter divider 120. This reset pulse resets first counter divider 112, starting another valve cycle and also resets second counter/dividers 118 and third counter/divider 120 restarts the time period to the next reset pulse. Comparator 138 compares the resistance value of second potentiometer 140 to the resistance value of thermistor 142. Thermistor 142 is a temperature dependant resistor and is utilized as a temperature sensor. If comparator 138 determines that the temperature sensed by thermistor 142 is above the temperature setpoint determined by second potentiometer 140, the output voltage level of comparator 138 goes to a LOW and prevents the reset pulse from third counter/divider 120 from passing through gate 114. This causes valve assembly to cease delivery of fluid at the completion of the current cycle. In many instances fluid injection is not required above certain temperatures. One of a plurality of switches 144 provided in a switch bank 146 over-rides this feature and allows delivery of chemical under all temperature conditions. External input provides a means for an external temperature sensing device to control the operation of the circuit with a logic level. External input provides a means for remote on/off operation by a logic level applied to the clock enable input of second counter/divider 118.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

1. An apparatus for reducing operating costs, maintenance costs and emissions in a fluid injection system, comprising:
a valve assembly adapted to be connected to a fluid injection point located on a well;
the valve assembly having an electronic controller, a flow passage, a plurality of solenoid valves positioned in the flow passage, and a metering chamber positioned in the flow passages that is adapted to receive a fluid flowing along the flow passage and discharge the fluid through the flow passage into the injection point;
the electronic controller supplying signals to selectively open and close each of the plurality of solenoid valves to control the flow of the fluid along the flow passage into the metering chamber and to control the discharge of the fluid from the metering chamber along the flow passage into the injection point;
means for supplying power to the electronic controller; and
means for supplying fluid to the flow passage.

2. The apparatus as defined in claim 1, wherein the means for supplying fluid to the flow passage is a container positioned at an elevation above that of the injection point such that fluid is flows to the flow passage by force of gravity.

3. The apparatus as defined in claim 1, wherein the means for supplying power to the electronic controller is a battery.

4. The apparatus as defined in claim 3, wherein the battery has a charging circuit.

5. The apparatus as defined in claim 1, wherein the opening and closing of each of the plurality of solenoid valves to control the flow of the fluid into the metering chamber and to control the discharge of the fluid from the metering chamber into the injection point is repeated in cycles.

6. The apparatus as defined in claim 5, wherein the flow of fluid is determined by the number of cycles and the volume of the metering chamber.

7. The apparatus as defined in claim 1, wherein the injection point is located on a casing of a wellhead of the well.

8. The apparatus as defined in claim 1, wherein the injection point is located on a flow line of the well.

9. The apparatus as defined in claim 1, wherein the injection point is located on a flow “T” of the well.

10. A method of reducing operating costs, maintenance costs and emissions in a fluid injection system, comprising the steps of:
providing a the valve assembly having an electronic controller, a flow passage, a plurality of solenoid valves positioned in the flow passage, and a metering chamber adapted to receive a fluid from the flow passage and discharge fluid flowing through the flow passage into the injection point
connecting the flow passage of the valve assembly to a fluid injection point located on a well such the metering chamber can discharge fluid into the injection point;
providing a supply of fluid to the flow passage; and
supplying power to the electronic controller such that the electronic controller sends electronic signals to selectively open and close each of the solenoid valves to valves to control the flow of the fluid into the metering chamber and to control the discharge of the fluid from the metering chamber into the injection point.

11. The method as defined in claim 10, wherein the injection point is located on a casing of a wellhead of the well.

12. The method as defined in claim 10, wherein the injection point is located on a flow line of the well.

13. The method as defined in claim 10, wherein the injection point is located on a flow “T” of the well.

14. The method as defined in claim 10, fluid is provided to the flow passage from a container positioned at an elevation above that of the injection point such that fluid is flows to the flow passage by force of gravity.
